(19) United States
(12) Patent Application Publication
(10) Pub. No.: US 2010/0330406 A1
(43) Pub. Date: Dec. 30, 2010

(54) ELECTRONIC DEVICE WITH BATTERY

(75) Inventors: WEI-JUN WANG, Shenzhen City (CN); ZI-MING TANG, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/542,121

(22) Filed: Aug. 17, 2009

(30) Foreign Application Priority Data
Jun. 26, 2009 (CN) 200910303752.4

(51) Int. Cl. H01M 2/10

(52) U.S. Cl. 429/97

(57) ABSTRACT

An electronic device includes a main body including a chamber thereon, at least one latching portion defined in an inner side surface of the chamber, a battery received in the chamber, a battery cover to seal the chamber, an electrode connecting member fixed to the battery cover and contacting the battery in the chamber, at least one latching member fixed to a side surface of the electrode connecting member according to the at least one latching portion, and a resilient member compressed between the battery cover and the electrode connecting member to apply a resilient force to pull the battery cover and the electrode connecting member outward. The at least one latching member is blocked by the at least one latching portion.

### BACKGROUND

1. Technical Field

The present disclosure relates to electronic devices, and particularly, to an electronic device having a battery.

2. Description of the Related Art

An electronic device, such as a wireless keyboard, a wireless touchpad, a remote control, and the like, usually includes a battery to provide electrical power. A typical electronic device includes a main body, a chamber defined in the main body, a battery received in the chamber, and a battery cover sealing the chamber. The chamber defines a latching groove in an inner surface of the chamber. The battery cover includes a latching protrusion locked in the latching groove, such that, the battery cover is engaged into an opening of the chamber to fix the battery in the chamber.

However, the latching protrusion of the battery cover tends to abrade easily after excessive use, which may cause a slack between the latching protrusion and the latching groove, resulting in a loose battery in the battery holder.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a first embodiment of an electronic device.

FIG. 2 is an assembled, isometric view of the electronic device of FIG. 1.

FIG. 3 is a side, cross-sectional view of the electronic device of FIG. 1 taken along line III-III.

FIG. 4 is a side, cross-sectional view of a second embodiment of an electronic device.

### DETAILED DESCRIPTION

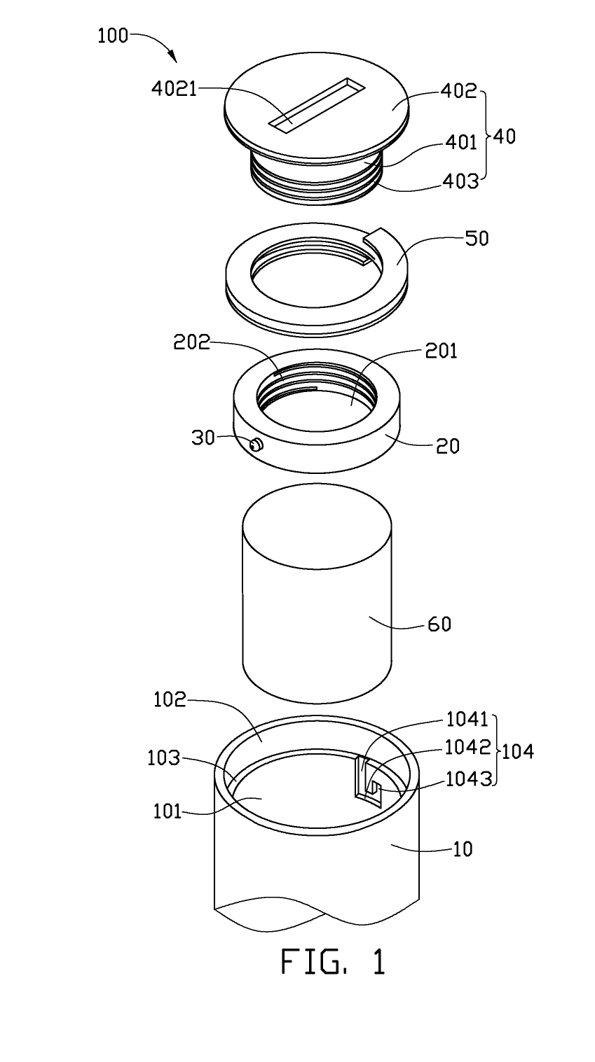

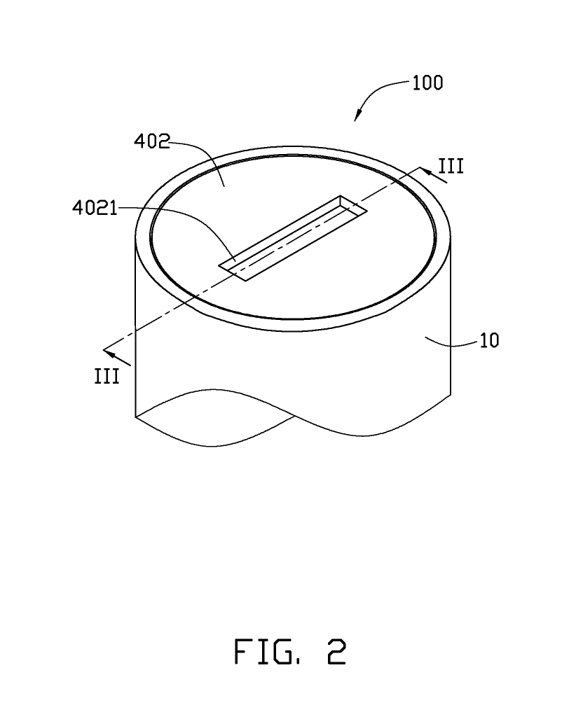

Referring to FIGS. 1 and 2, a first embodiment of an electronic device 100 includes a main body 10, an electrode connecting member 20, two latching members 30, a battery cover 40, a resilient member 50, and a battery 60. The electronic device 100 may be a wireless keyboard, a wireless touchpad, a remote control, and the like. In the illustrated embodiment, the electronic device 100 is a wireless keyboard.

The main body 10 defines a columnar chamber 101 to receive the battery 60. The chamber 101 includes an opening 102. The main body 10 further defines a ledge 103 along an inner wall of the chamber 101 adjacent to the opening 102. The ledge 103 blocks the resilient member 50 from sliding into the chamber 101. The main body 10 further includes two latching portions 104 defined in the inner side surface of the chamber 101 and facing each other.

The electrode connecting member 20 is fixed to the battery cover 40, and contacts an electrode of the battery 60 in the chamber 101. The latching members 30 are fixed to a side surface of the electrode connecting member 20 corresponding to the latching portions 104. The resilient member 50 is compressed between the battery cover 40 and the electrode connecting member 20 to apply a restoring elastic force to urge the battery cover 40 and the electrode connecting member 20 toward the opening 102. The latching members 30 are blocked by the latching portions 104.

In the illustrated embodiment, each latching portion 104 is a hook-shaped latching depression defined in an inner side surface of the chamber 101. The latching portion 104 includes a first guide depression 1041, a second guide depression 1042, and a third guide depression 1043. The first guide depression 1041 extends substantially perpendicularly from the ledge 103 downwards along a direction substantially parallel to a center axis of the main body 10. The second guide depression 1042 extends from a bottom end of the first guide depression 1041 along a circumference substantially perpendicular to the center axis of the main body 10. The third guide depression 1043 extends upward from an end of the second guide depression 1042 along a direction substantially parallel to the first guide depression 1041. A length of the third guide depression 1043 is less than that of the first guide depression 1041.

In the illustrated embodiment, the electrode connecting member 20 is substantially a columnar structure. The electrode connecting member 20 includes a screw hole 201 in an upper surface of the electrode connecting member 20, and a screw threading 202 defined in an inner surface of the screw hole 201.

In the illustrated embodiment, each of the latching members 30 is a protrusion fixed to an outer side surface of the electrode connecting member 20.

In the illustrated embodiment, the battery cover 40 includes a columnar body 401 and a cover plate 402. The columnar body 401 extends out from a bottom surface of the cover plate 402. The battery cover 40 further defines a screw threading 403 at an outer surface of the columnar body 401 corresponding to the screw threading 202 of the screw hole 201 of the electrode connecting member 20. Accordingly, the electrode connecting member 20 may be fixed to the body 401 of the battery cover 40 by screwing the body 401 into the screw hole 201 of the connecting member 20. The battery cover 40 may further define an elongated mounting depression 4021 in an upper surface of the cover plate 402 that is easily engageable by a screwdriver to assemble or disassemble the battery cover 40 to the main body 10.

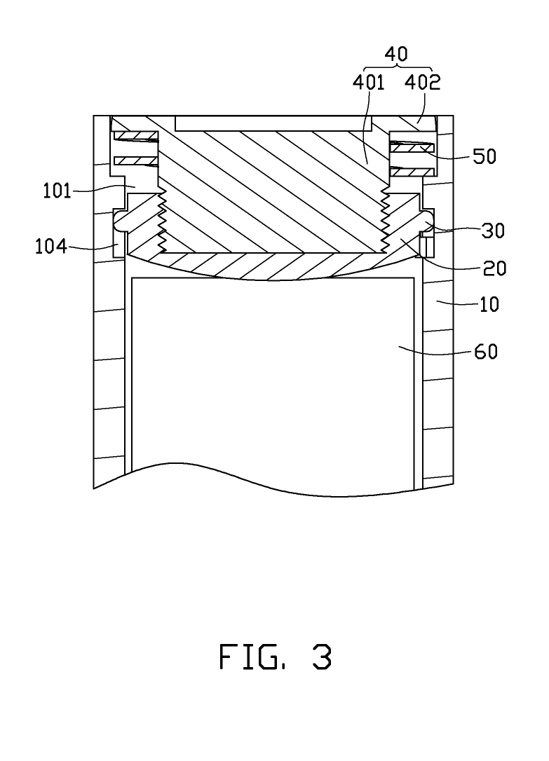

The resilient member 50 is a columnar spring. Referring to FIG. 3, an inner diameter of the resilient member 50 is larger than or equal to a diameter of the columnar body 401 of the battery cover 40, and less than an outer diameter of the electrode connecting member 20.

In use, to assemble the battery cover 40, the latching member 30, and the electrode connecting member 20 into the chamber 101 of the main body 10, the resilient member 50 is first sleeved on a side surface of the body 401 of the battery cover 40. A part of the body 401 of the battery cover 40 is then screwed into the screw hole 201 of the electrode connecting member 20. The two latching members 30 are slid along the corresponding first guide depressions 1041 into the chamber 101 until two ends of the resilient member 50 resists the battery cover 40 and the ledge 103. The battery cover 40 is then pressed and rotated by an external force to slide the latching members 30 along the second guide depressions 1042 to the other end of the second guide depression 1042. At this time, the resilient member 50 is compressed. Finally, when the external force is withdrawn, the electrode connecting member 20 and the battery cover 40 moves toward the opening 102 of the chamber 101 due to a restoring elastic force from the resilient member 50. At this time, the latching members 30 slide toward the opening 102 along the third guide depression 1043, until the latching members 30 are blocked by the corresponding latching portions 104.

To disassemble the battery cover 40 from the chamber 101 of the main body 10, the battery cover 40 is pressed and rotated by an external force, and the latching members 30 slide along the third guide depression 1043 to an end of the second guide depression 1042 away from the third guide depression 1043. When the external force is withdrawn, the battery cover 40 with the electrode connecting member 20 can be pulled out, and the latching members 30 slide out of the chamber 101 along the first guide depression 1041.

In use, the latching members 30 are blocked by the corresponding latching portions 104 due to the restoring elastic force from the compressed resilient member 50, such that even though the latching members 30 are abraded after excessive working, a slack between the latching members 30 and the latching portions 104 will not exist due to the restoring elastic force.

It should be pointed out that the ledge 103 can be omitted, if the first guide depression 1041 of each latching portion 104 extends substantially perpendicularly from the end of the chamber 101 adjacent to the opening 102 downwards along a direction substantially parallel to a center axis of the chamber 101.

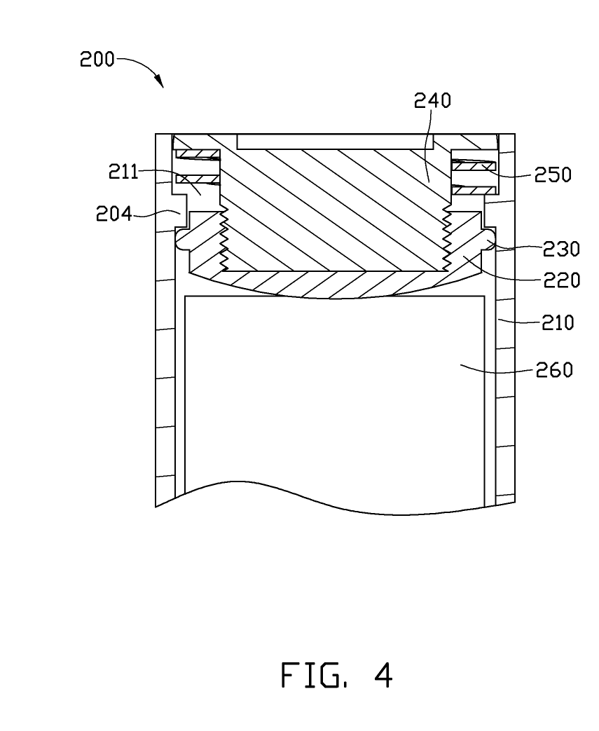

Referring to FIG. 4, a second embodiment of an electronic device 200 includes a main body 210, an electrode connecting member 220, two latching members 230, a battery cover 240, a resilient member 250, and a battery 260. The main body 210 defines a columnar chamber 211. The main body 210 further includes two latching portions 204 defined in an inner side surface of the chamber 101 and facing each other. The electronic device 200 is similar to the electronic device 100 of the first embodiment, except that each latching portion 204 is a protrusion extending out from an inner side surface of the chamber 211. Each latching member 230 is blocked by the latching portion 204. In alternative embodiments, the latching portions 204 may be an elongated protrusion or a hook-shaped protrusion.

It is should be noted that the configurations of the chamber 101, the body 401 and the cover plate 402 of the battery cover 40, are not limited to the configurations described above. The chamber 101, the body 401, and the cover plate 402 of the battery cover 40 can include any other suitable structures. For example, if the chamber 101 is rectangular, the body 401 of the battery cover 40 is also rectangular.

It is noted that the scope of the latching members 30, 230 or latching portions 104, 204 are not limited to the embodiments described above. The numbers of the latching members 30, 230 or latching portions 104, 204, are specifically described and illustrated for the purpose of exemplifying various aspects of the present electronic device 100, 200.

Finally, while the present disclosure has been described with reference to particular embodiments, the description is illustrative of the disclosure and is not to be construed as limiting the disclosure. Therefore, various modifications can be made to the embodiments by those of ordinary skill in the art without departing from the true spirit and scope of the disclosure as defined by the appended claims.

What is claimed is:

1. An electronic device, comprising:
a main body comprising a chamber defined therein, and at least one latching portion defined in an inner side surface of the chamber, the chamber comprising an opening;
a battery received in the chamber;
a battery cover;
an electrode connecting member fixed to the battery cover, and contacting an electrode of the battery in the chamber;
at least one latching member fixed to a side surface of the electrode connecting member corresponding to the at least one latching portion; and
a resilient member compressed between the battery cover and the electrode connecting member to apply a restoring elastic force to urge the battery cover and the electrode connecting member outward, wherein the at least one latching member is blocked by the at least one latching portion.

2. The electronic device of claim 1, wherein the electrode connecting member comprises a screw hole in an upper surface thereof, and a screw threading defined at an inner side surface of the screw hole; the battery cover comprises a cover plate, a columnar body extending out from a bottom surface of the cover plate, and a screw threading defined at an outer surface of the columnar body corresponding to the screw threading of the screw hole of the electrode connecting member; the electrode connecting member is fixed to the body of the battery cover by the screw threading of the battery cover engaged with the screw threading of the electrode connecting member.

3. The electronic device of claim 2, wherein the battery cover further defines an elongated mounting depression in an upper surface of the cover plate.

4. The electronic device of claim 1, wherein the resilient member is a spring.

5. The electronic device of claim 4, wherein an inner diameter of the resilient member is larger than or equal to a diameter of the columnar body of the battery cover, and less than an outer diameter of the electrode connecting member.

6. The electronic device of claim 1, wherein the at least one latching portion is a hook-shaped latching depression defined at an inner side surface of the chamber, the at least one latching portion comprising a first guide depression, a second guide depression, and a third guide depression; the first guide depression extends substantially perpendicularly from the end of the chamber adjacent to the opening downwards along a direction substantially parallel to a center axis of the main body; the second guide depression extends from a bottom end of the first guide depression along a circumference substantially perpendicular to the center axis of the main body; the third guide depression extends upward from an end of the second guide depression along a direction substantially parallel to the first guide depression.

7. The electronic device of claim 6, wherein a length of the third guide depression is less than that of the first guide depression.

8. The electronic device of claim 6, wherein the main body further defines a ledge along an inner wall of the chamber adjacent to the opening to block the resilient member from sliding into the chamber.

9. The electronic device of claim 1, wherein the at least one latching portion is a protrusion extending out from an inner side surface of the chamber.
